(19) United States
(12) Patent Application Publication
(10) Pub. No.: US 2026/0110602 A1
(43) Pub. Date: Apr. 23, 2026

(54) Reactor sampling device

(71) Applicant: DOOSAN ENERBILITY CO., LTD., Changwon (KR)

(72) Inventors: Hae Woong Kim, Changwon (KR); Ho Seok Nam, Busan (KR); Kwang Soo Park, Seoul (KR)

(21) Appl. No.: 19/361,220

(22) Filed: Oct. 17, 2025

(30) Foreign Application Priority Data
Oct. 21, 2024 (KR) 10-2024-0143948

(51) Int. Cl. G01N 1/08; G01N 1/02

(52) U.S. Cl. CPC G01N 1/08; G01N 2001/028

(57) ABSTRACT

Proposed is a reactor sampling device for collecting samples from an inner wall of a reactor, the device including a main body part having a receiving space and an opening part configured to be in contact with the inner wall, a sampling tool part disposed in the receiving space of the main body part and having a tool head configured to collect samples from the inner wall of the reactor through the opening part, a vertical movement part connected to the main body part and configured to move the main body part upward and downward, and a sample discharge part communicating with the receiving space and configured to discharge the samples collected by the sampling tool part to the outside of the main body part.

### CROSS REFERENCE TO RELATED APPLICATION

The present application claims priority to Korean Patent Application No. 10-2024-0143948, filed on Oct. 21, 2024, the entire contents of which are incorporated herein for all purposes by this reference.

### BACKGROUND

### 1. Technical Field

The present disclosure relates to a reactor sampling device that collects depth-specific samples from the inner wall of a reactor during nuclear power plant decommissioning.

### 2. Description of the Background Art

In general, in order to evaluate the characteristics of an on-site and activated equipment and structures during decommissioning of a nuclear power plant, samples must be collected for radioactive nuclides and chemical analysis on the metal surfaces of activated structures such as a reactor and primary system equipment.

One conventional method for collecting internal samples is to use smear paper to collect samples and then measure the samples by using a detector. However, this method carries a high risk of radiation exposure because a person must directly rub a contaminated area with the smear paper to collect a contaminated sample.

To address this, recently, a sampling device that collects one-piece sample cut through electrical discharge machining (EDM) has been used.

However, in the case of the sampling device that collects samples by cutting the samples by using electric discharge machining, when samples are collected underwater inside a reactor, the samples are mixed with contaminated water, making accurate measurement of the samples difficult. In addition, there are limitations in collecting samples from different depths of the inner wall of the reactor.

The related technology for sampling devices used for activated structures is disclosed in Korean Patent No. 10-1646598 (2016.08.02).

### SUMMARY

Accordingly, the present disclosure has been made keeping in mind the above problems occurring in the related art, and an objective of the present disclosure is to provide a reactor sampling device that prevents samples from mixing with contaminated water inside a reactor and enables the collection of depth-specific samples from the inner wall of the reactor.

In order to achieve the above objective, according to an embodiment of the present disclosure, there is provided a reactor sampling device for collecting samples from an inner wall of a reactor, the device including: a main body part having a receiving space and an opening part configured to be in contact with the inner wall; a sampling tool part disposed in the receiving space of the main body part and having a tool head configured to collect samples from the inner wall of the reactor through the opening part; a vertical movement part connected to the main body part and configured to move the main body part upward and downward; and a sample discharge part communicating with the receiving space and configured to discharge the samples collected by the sampling tool part to the outside of the main body part.

In addition, the main body part may be provided with an intake port and a sample discharge port which communicate with the receiving space.

In addition, the main body part may include an intake injection space that communicates with the intake port and is provided with a plurality of nozzle holes.

In addition, an inner bottom of the main body part may include a discharge guide provided with a downwardly inclined slope.

In addition, the discharge guide may be disposed at a lower side of the opening part.

In addition, the device may further include: a fixing part connected to the main body part and configured to maintain the main body part, which is in contact with the inner wall of the reactor, in a fixed state.

In addition, the fixing part may include: a fixing body having an adjustable length; and a fixing driving means connected to the fixing body and configured to generate a driving force to adjust a length of the fixing body.

In addition, the device may further include: a sealing means provided on the main body part for sealing between the main body part and the inner wall of the reactor.

In addition, the sampling tool part may include: a tool body configured to support the tool head so that the tool head is rotatable, with the tool body disposed in the receiving space of the main body part so as to be slidably moved in a horizontal direction; a sampling driving means connected to the tool head and configured to generate a driving force to rotate the tool head; and a sampling moving means configured to generate a driving force to cause the tool body to slide within the receiving space.

In addition, the sample discharge part may include: an intake line that communicates with the receiving space; an exhaust line that communicates with the receiving space; an external air supply means disposed on the intake line and configured to supply outside air to the receiving space of the main body part; and a sample discharge means disposed on the exhaust line and configured to generate back pressure to discharge samples inside the receiving space of the main body part through the exhaust line.

In addition, the device may further include: a controller configured to control operations of the sampling tool part and the sample discharge part.

In addition, the controller may control a depth to which the sampling tool part is inserted into the inner wall of the reactor according to a material of the inner wall of the reactor.

In addition, the controller may control the operation of the sampling tool part to adjust a depth to which the tool head of the sampling tool part is into the inner wall of the reactor when collecting samples from the inner wall of the reactor, and the operation of the sample discharge part to discharge the samples to the outside of the main body part after the samples are completely collected from the inner wall of the reactor by the tool head.

In addition, the controller may perform a cleaning operation to discharge remaining samples from within the receiving space of the main body part to the outside when collecting samples from different target depths of the inner wall of the reactor.

In the reactor sampling device according to the present disclosure, the main body part is disposed such that the opening part is in close contact with the inner wall of the reactor, and through the sampling tool part arranged within the receiving space of the main body part, samples are collected at various depths of the inner wall of the reactor. The samples collected from the sampling tool part can be discharged to the outside of the reactor through the sample discharge part without mixing with contaminated water inside the reactor.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows the configuration diagram of a reactor sampling device according to an embodiment of the present disclosure;

FIG. 2 shows the operating state diagram of the reactor sampling device according to the embodiment of the present disclosure;

FIG. 3 is an enlarged view of part “A” shown in FIG. 2; and

FIG. 4 is a partial cross-sectional view of a reactor sampling device according to another embodiment of the present disclosure.

### DETAILED DESCRIPTION

Hereinafter, exemplary embodiments of the present disclosure will be described in detail with reference to the accompanying drawings. Prior to this, terms and words used in this specification and claims should not be construed as limited to their usual or dictionary meanings, and based on the principle that the inventor can appropriately define the concepts of the terms in order to explain his or her invention in the best way, the terms are required to be interpreted as meanings and concepts consistent with the technical idea of the present disclosure.

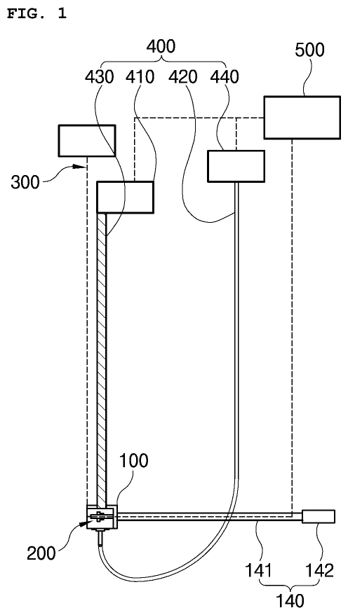

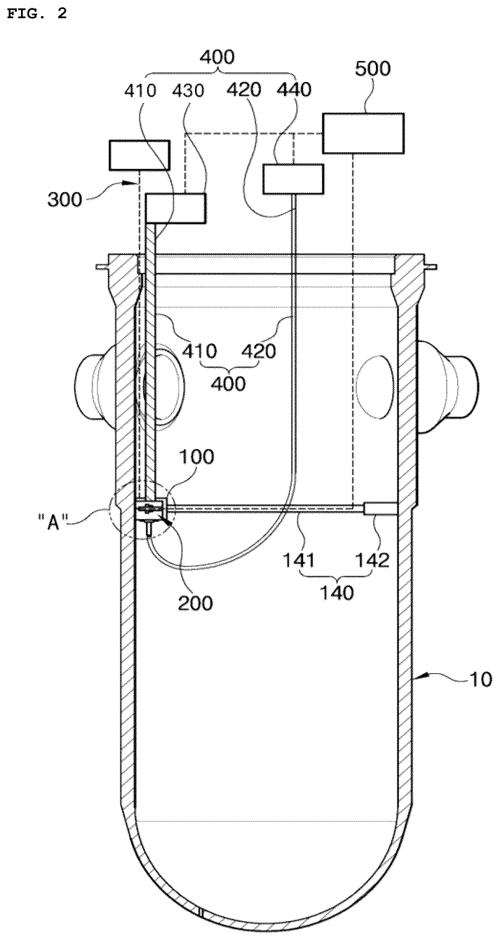

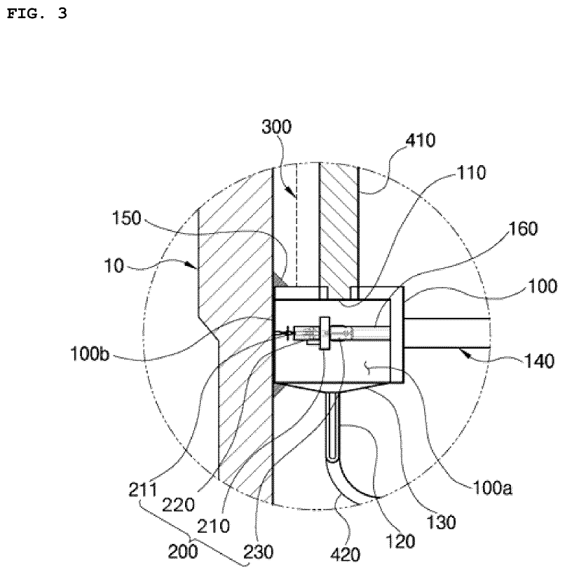

Referring to FIGS. 1 to 4, a reactor sampling device according to an embodiment of the present disclosure may include a main body part 100, a sampling tool part 200, a vertical movement part 300, and a sample discharge part 400.

The main body part 100 may be disposed in close contact with the inner wall of a reactor 10.

The main body part 100 may include a receiving space 100a configured to accommodate the sampling tool part 200 and to store samples collected by the operation of the sampling tool part 200.

The main body part 100 may have a hexahedral shape (e.g., a cuboid), and include an opening part 100b, which communicates with the receiving space 100a, provided on a portion facing the inner wall of the reactor 10. The opening part 100b allows a tool head 211 of the sampling tool part 200 to protrude from the receiving space 100a to the outside of the main body part 100 toward the inner wall of a reactor 10, enabling the tool head 211 to collect samples from the inner wall of the reactor 10 and allowing the collected samples to be accommodated in the receiving space 100a.

In addition, the main body part 100 may be provided with an intake port 110 and a sample discharge port 120 which communicate with the receiving space 100a.

For example, the intake port 110 may be disposed on the upper surface of the main body part 100, and the sample discharge port 120 may be disposed on the lower surface of the main body part 100.

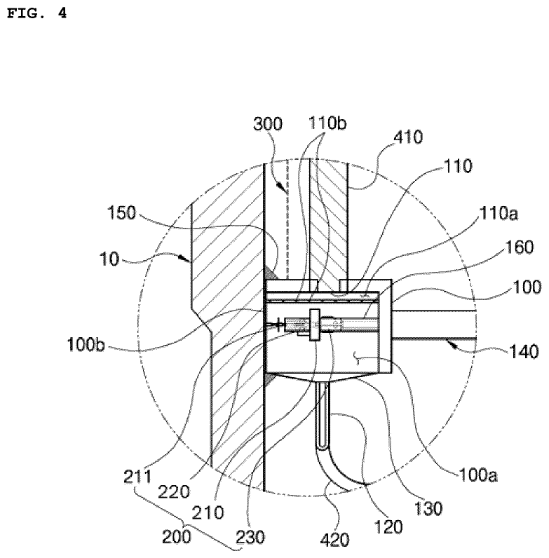

Referring to FIG. 4, according to an embodiment, an intake injection space 110a communicating with the intake port 110 may be formed in the upper portion of the main body part 100.

Specifically, according to an embodiment, the internal space of the main body part 100 may be divided by a separation partition wall into the receiving space 100a and the intake injection space 110a, such that the receiving space 100a is defined below the separation partition wall and the intake injection space 110a may be defined above the separation partition wall.

In addition, a plurality of nozzle holes 110b communicating with the intake injection space 110a may be formed in the separation partition wall. Through the nozzle holes 110b, outside air introduced into the intake injection space 110a through the intake port 110 may be evenly injected into the receiving space 100a of the main body part 100. The nozzle holes 110b may allow the introduced outside air to be sprayed throughout the receiving space 100a, thereby preventing samples accommodated in the receiving space 100a from adhering to and remaining attached to the inner surface of the main body part 100 and allowing the samples to be completely discharged through the sample discharge port 120.

In addition, a downwardly inclined slope 130 may be provided on the inner bottom of the main body part 100.

For example, the inclined slope 130 may be disposed at the lower side of the opening part 100b and may guide samples collected by the tool head 211 of the sampling tool part 200 to move toward the sample discharge port 120 by free fall under gravity.

Furthermore, the main body part 100 may be provided with a fixing part 140 connected to the main body part 100. The fixing part 140 may maintain the main body part 100, which is disposed to be in close contact with the inner wall of the reactor 10, in a fixed state. According to an embodiment, the fixing part 140 may apply a push force to support the main body part 100 against the inner wall of the reactor 10.

For example, the fixing part 140 may extend horizontally and include a fixing body 141 and a fixing driving means 142. Opposite ends of the fixing part 140 may be referred to as a first longitudinal end and a second longitudinal end, respectively.

The fixing body 141 has a length-adjustable structure. For example, the fixing body 141 may be configured as a telescopic structure.

The first longitudinal end of the fixing body 141 may be connected to the main body part 100, and the second longitudinal end of the fixing body 141 may be disposed to be in contact with the inner wall of the reactor 10.

When the inner wall of the reactor includes two opposing wall portions, the first longitudinal end of the fixing body 141 may be connected to the main body part 100 in contact with one of the wall portions, and the second longitudinal end of the fixing body 141 may be in contact with the opposing inner wall portion. The inner wall of the reactor 10 may be generally have a cylindrical shape. The fixing driving means 142 may be connected to the fixing body 141. The fixing driving means 142 may generate a driving force to adjust the length of the fixing body 141.

For example, the fixing driving means 142 may be a hydraulic cylinder.

By operation of the hydraulic cylinder, the fixing driving means 142 may adjust the length of the fixing body 141.

However, fixing driving means 142 may be implemented as any hardware structure that may provide push and pull force to change the length of the fixing body 141.

According to an embodiment, when the fixing driving means 142 is implemented as a hydraulic cylinder, the body portion of the hydraulic cylinder may be disposed at the first longitudinal end of the fixing body 141, and an end of the rod of the hydraulic cylinder may be connected to the second longitudinal end of the fixing body 141. Through this configuration, the length of the fixing body 141 may be adjusted by extension or retraction of the rod according to the operation of the hydraulic cylinder, and the main body part 100 may be pressed against the inner wall of the reactor 10, thereby maintaining a stable fixed state thereof.

In addition, according to an embodiment, a sealing means 150 may be disposed on the main body part 100 to provide sealing between the main body part 100 and the inner wall of the reactor 10 when the main body part 100 is disposed to be in close contact with the inner wall of the reactor 10.

For example, the sealing means 150 may be implemented as a suction pad arranged along the periphery of the contact surface of the main body part 100, that is in close contact with the inner wall of the reactor 10. The sealing means 1510 may be implemented as any flexible material that may fill a gap between the main body part 100 and the inner wall of the reactor 10.

Furthermore, a horizontal guide 160 may be provided inside the main body part 100 to guide a tool body 210 of the sampling tool part 200 to be movable in a horizontal direction within the receiving space 100a.

The sampling tool part 200 may be disposed in the receiving space 100a of the main body part 100.

Accordingly, the sampling tool part 200 may penetrate into the inner wall of the reactor 10 and collects sample from the inner wall.

The sampling tool part 200 may include the tool body 210, a sampling driving means 220, and a sampling moving means 230.

The tool body 210 may be disposed to be slidably movable in the horizontal direction within the receiving space 100a of the main body part 100. According to an embodiment, the tool body 210 may be slidably connected to the horizontal guide 160 of the main body part 100.

In addition, the tool head 211 may be rotatably mounted on the tool body 210 to penetrate into the inner wall of the reactor 10 by rotation thereof.

For example, the tool head may be implemented as one of a drill bit and an end mill.

The sampling driving means 220 may be disposed on the tool body 210 to be connected to the tool head 211.

Accordingly, the sampling driving means 220 generates a driving force to rotate the tool head 211, enabling the tool head 211 to penetrate into the inner wall of the reactor 10 and collect samples.

For example, the sampling driving means 220 may be a motor. The sampling driving means 220 may be implemented as any hardware structure that may provide a rotational force to rotate the tool head 211.

The sampling moving means 230 may be connected to the tool body 210.

Accordingly, the sampling moving means 230 may generate a driving force to slidably move the tool body 210 on the horizontal guide 160 within the receiving space 100a.

The sampling moving means 230 may allow the tool body 210 to be slidably moved back and forth on the horizontal guide 160, enabling adjustment of depth to which the tool head 211 is inserted into the inner wall of the reactor 10.

For example, the sampling moving means 230 may be a hydraulic cylinder. The sampling moving means 230 may be implemented as any hardware structure that may provide push and pull force to the tool body 210 to change the horizontal position of the tool body 210.

When the sampling moving means 230 is implemented as a hydraulic cylinder, the body portion of the hydraulic cylinder may be disposed on the main body part 100, and the end of the rod of the hydraulic cylinder may be connected to the tool body 210. Through this configuration, the horizontal position of the tool body 210 may be adjusted according to extension or retraction of the rod by operation of the hydraulic cylinder.

For another example, the sampling moving means 230 may be implemented with a rack-and-pinion gear and a motor. In this case, a rack gear may be disposed on the horizontal guide 160, and a pinion gear may be disposed on the tool body 210 to engage with the rack gear. In addition, the motor may be disposed on the tool body 210 and connected to the pinion gear. Through this configuration, the position of the tool body 210 may be adjusted on the horizontal guide 160 according to the rotational direction of the pinion gear driven by the motor.

The vertical movement part 300 may be connected to the main body part 100.

Accordingly, the vertical movement part 300 moves the main body part 100 upward or downward to adjust a vertical position thereof on the inner wall of the reactor 10 from which samples are collected by the sampling tool part 200.

For example, the vertical movement part 300 may be a hydraulic cylinder connected to the main body part 100. When the vertical movement part 300 is implemented as a hydraulic cylinder, the body portion of the hydraulic cylinder may be disposed on the upper outside of the reactor 10, and the end of the rod of the hydraulic cylinder may be connected to the main body part 100. Through this configuration, the vertical position of the main body part 100 may be adjusted according to extension or retraction of the rod by operation of the hydraulic cylinder.

In another example, the vertical movement part 300 may be implemented with a rack-and-pinion gear and a motor. In this case, a rack gear may be vertically disposed, with a lower end thereof connected to the main body part 100 and an upper end thereof disposed on the upper outside of the reactor 10. In addition, a pinion gear may be disposed on the main body part 100 to engage with the rack gear. In addition, the motor may be disposed on the main body part 100 and connected to the pinion gear. Through this configuration, the main body part 100 can be moved upward or downward along the rack gear according to the rotational direction of the pinion gear driven by the motor.

In yet another example, the vertical movement part 300 may be implemented with a lifting reel and a lifting wire.

In this case, the lifting reel may be disposed on the upper outside of the reactor 10, and one longitudinal end of the lifting wire, which is wound around the lifting reel, may be connected to the main body part 100. Through this configuration, the main body part 100 can be moved upward or downward by winding or unwinding the lifting wire according to the rotational direction of the lifting reel.

The sample discharge part 400 may communicate with the receiving space 100a of the main body part 100.

Accordingly, the sample discharge part 400 may discharge samples collected by the sampling tool part 200 to the outside of the main body part 100.

The sample discharge part 400 may include an intake line 410, an exhaust line 420, an external air supply means 430, and a sample discharge means 440.

The intake line 410 and the exhaust line 420 may be pipe members communicating with the receiving space 100a of the main body part 100. The intake line 410 may guide external air from outside the reactor 10 into the receiving space 100a of the main body part 100, while the exhaust line 420 may guide air inside the main body part 100 together with samples collected by the sampling tool part 200 to be discharged outside the reactor 10.

Accordingly, a first longitudinal end of the intake line 410 may communicate with the intake port 110 of the main body part 100, and a second longitudinal end of the intake line 410 may be connected to the external air supply means 430 disposed outside the reactor 10.

Likewise, a first longitudinal end of the exhaust line 420 may communicate with the sample discharge port 120 of the main body part 100, and a second longitudinal end of the exhaust line 420 may be connected to the sample discharge means 440 disposed outside the reactor 10.

In addition, a sample storage container (not shown) capable of holding and storing collected samples may be detachably provided on the second longitudinal end of the exhaust line 420.

The external air supply means 430 may be disposed on the intake line 410. The external air supply means 430 may be connected to a portion of the intake line 410 disposed outside the reactor 10.

For example, the external air supply means 430 may be implemented as a blower fan or a blower pump. The external air supply means 430 may be implemented as any hardware structure that may generate air flow toward the intake line 410.

The sample discharge means 440 may be disposed on the exhaust line 420. The sample discharge means 440 may be connected to a portion of the exhaust line 420 disposed outside the reactor 10.

For example, the sample discharge means 440 may be a suction pump. The sample discharge means 440 may be implemented as any hardware structure that may generate a suction force that draw air and/or materials from the exhaust line 420.

The reactor sampling device according to an embodiment may further include a controller 500 configured to control the operations of the sampling tool part 200 and the sample discharge part 400.

Accordingly, the controller 500 controls the operations of the sampling tool part 200 and the sample discharge part 400, so that different samples can be collected by adjusting depth to which the tool head 211 of the sampling tool part 200 is inserted into the inner wall of the reactor 10 according to the material of the inner wall of the reactor 10.

Accordingly, when collecting samples from the inner wall of the reactor 10, the controller 500 may control the operations of the sampling driving means 220 and the sampling moving means 230 of the sampling tool part 200 to adjust the insertion depth of the tool head 211 of the sampling tool part 200 into the inner wall of the reactor 10. In addition, the controller 500 may control the operations of the external air supply means 430 and the sample discharge means 440 of the sample discharge part 400 so that the samples collected by the tool head 211 from the inner wall of the reactor 10 are discharged to the outside of the main body part 100 after the sample collection is completed.

In addition, after samples are collected from the inner wall of the reactor 10, the controller 500 may perform a cleaning operation to discharge remaining samples from within the receiving space 100a of the main body part 100 to the outside. The operation of cleaning can be performed by introducing air from the external air supply means 430 into the receiving space 100a. This prevents samples collected from different depths from mixing, thereby improving the accuracy of the sample collection.

In operation, the controller 500 may operates the sampling driving means 220 and the sampling moving means 230 so that the tool head 211 is rotated and inserted into the inner wall of the reactor 10 to a target depth from which a sample is to be collected, thereby enabling collection of a target sample from the inner wall of the reactor 10. The sample collection operation may be completed by discharging the collected samples to the outside of the main body part 100 through the operations of the external air supply means 430 and the sample discharge means 440 of the sample discharge part 400.

Thus, in the reactor sampling device according to one embodiment, the main body part 100 is disposed such that the opening part 100b is in close contact with the inner wall of the reactor 10, and through the sampling tool part 200 arranged within the receiving space 100a of the main body part 100, samples are collected at various depths of the inner wall of the reactor 10. The samples collected from the sampling tool part 200 may be discharged to the outside of the reactor 10 through the sample discharge part 400 without mixing with contaminated water inside the reactor 10.

The present disclosure has been described with reference to the embodiments illustrated in the drawings, but these embodiments are merely illustrative, and those skilled in the art will understand that various modified embodiments and equivalent other embodiments are possible therefrom. Also, it is noted that any one feature of an embodiment of the present disclosure described in the specification may be applied to another embodiment of the present disclosure. Similarly, the present invention encompasses any embodiment that combines features of one embodiment and features of another embodiment. Therefore, the scope of technical protection of the present disclosure should be determined by the technical spirit of the attached claims.

1. A reactor sampling device for collecting samples from an inner wall of a reactor, the device comprising:
a main body part having a receiving space and an opening part configured to be in contact with the inner wall;
a sampling tool part disposed in the receiving space of the main body part and having a tool head configured to collect samples from the inner wall of the reactor through the opening part;
a vertical movement part connected to the main body part and configured to move the main body part upward and downward; and
a sample discharge part communicating with the receiving space and configured to discharge the samples collected by the sampling tool part to the outside of the main body part.

2. The device of claim 1, wherein the main body part is provided with an intake port and a sample discharge port which communicate with the receiving space.

3. The device of claim 2, wherein the main body part comprises an intake injection space that communicates with the intake port and is provided with a plurality of nozzle holes.

4. The device of claim 1, wherein an inner bottom of the main body part comprises a discharge guide provided with a downwardly inclined slope.

5. The device of claim 4, wherein the discharge guide is disposed at a lower side of the opening part.

6. The device of claim 1, further comprising:
a fixing part connected to the main body part and configured to maintain the main body part, which is in contact with the inner wall of the reactor, in a fixed state.

7. The device of claim 6, wherein the fixing part comprises:
a fixing body having an adjustable length; and
a fixing driving means connected to the fixing body and configured to generate a driving force to adjust a length of the fixing body.

8. The device of claim 1, further comprising:
a sealing means provided on the main body part for sealing between the main body part and the inner wall of the reactor.

9. The device of claim 1, wherein the sampling tool part comprises:
a tool body configured to support the tool head so that the tool head is rotatable, with the tool body disposed in the receiving space of the main body part so as to be slidably moved in a horizontal direction;
a sampling driving means connected to the tool head and configured to generate a driving force to rotate the tool head; and
a sampling moving means configured to generate a driving force to cause the tool body to slide within the receiving space.

10. The device of claim 1, wherein the sample discharge part comprises:
an intake line that communicates with the receiving space;
an exhaust line that communicates with the receiving space;
an external air supply means disposed on the intake line and configured to supply outside air to the receiving space of the main body part; and
a sample discharge means disposed on the exhaust line and configured to generate back pressure to discharge samples inside the receiving space of the main body part through the exhaust line.

11. The device of claim 1, further comprising:
a controller configured to control operations of the sampling tool part and the sample discharge part.

12. The device of claim 11, wherein the controller controls a depth to which the sampling tool part is inserted into the inner wall of the reactor according to a material of the inner wall of the reactor.

13. The device of claim 12, wherein the controller controls
the operation of the sampling tool part to adjust a depth to which the tool head of the sampling tool part is inserted into the inner wall of the reactor when collecting samples from the inner wall of the reactor, and
the operation of the sample discharge part to discharge the samples to the outside of the main body part after the samples are completely collected from the inner wall of the reactor by the tool head.

14. The device of claim 13, wherein the controller performs a cleaning operation to discharge remaining samples from within the receiving space of the main body part to the outside when collecting samples from different target depths of the inner wall of the reactor.
